(19) United States
(12) Patent Application Publication
(10) Pub. No.: US 2011/0235312 A1
(43) Pub. Date: Sep. 29, 2011

(54) CRIMPING TOOLS HAVING LIGHTING ASSEMBLIES

(75) Inventors: MATTHEW STEVEN HOUSER, JONESTOWN, PA (US); RICHARD LLOYD SCHAEFFER, CARLISLE, PA (US)

(73) Assignee: TYCO ELECTRONICS CORPORATION, BERWYN, PA (US)

(21) Appl. No.: 12/731,761

(22) Filed: Mar. 25, 2010

(51) Int. Cl. B25B 23/18

(52) U.S. Cl. 362/119

(57) ABSTRACT

A crimping tool for crimping a terminal to a wire includes a tool head having a die assembly defining a crimping zone. The die assembly is configured to crimp the terminal to the wire in the crimping zone during a crimping operation. An actuator is coupled to the tool head and operatively coupled to the die assembly to actuate the die assembly during the crimping operation. A lighting assembly is coupled to the tool head. The lighting assembly illuminates the crimping zone.

### BACKGROUND OF THE INVENTION

The subject matter herein relates generally to termination tools, and more particularly, to hand-held crimping tools.

Pressing devices are employed in numerous applications to provide a user with a desired mechanical advantage. One exemplary application is in crimping tools used for making crimping connections, such as crimping terminals onto conductors. The crimping tool typically includes a tool head having tooling appropriate for the particular application and an actuator connected to the tool head for driving the tooling. The tool head typically includes a fixed die and movable die that is driven towards the fixed die to perform the crimping operation. The actuator may be mechanically driven by opposed levers, hydraulically driven, pneumatically driven, or driven by other actuation means.

Crimps are often produced in locations with inadequate lighting, making the terminal crimping area of the crimping tool difficult to see. For example, because the terminals and wires may be small, it may be difficult to see the crimping zone for proper placement of the terminal and/or the wire. Additionally, the tool head may entirely surround the crimping zone, casting shadows on the crimping zone, making it difficult to see the crimping area. Because the crimping area is difficult to see, operators can have difficulty correctly placing terminals in the crimping nests of the dies, and can have difficulty crimping the terminals.

A need remains for a crimping tool that illuminates the crimping area of the crimping tool.

### BRIEF DESCRIPTION OF THE INVENTION

In one embodiment, a crimping tool for crimping a terminal to a wire is provided that includes a tool head having a die assembly defining a crimping zone. The die assembly is configured to crimp the terminal to the wire in the crimping zone during a crimping operation. An actuator is coupled to the tool head and operatively coupled to the die assembly to actuate the die assembly during the crimping operation. A lighting assembly is coupled to the tool head. The lighting assembly illuminates the crimping zone.

In another embodiment, a crimping tool is provided for crimping a terminal to a wire including a tool head having a frame and a die assembly coupled to the frame. The die assembly defines a crimping zone and is configured to crimp the terminal to the wire in the crimping zone during a crimping operation. An actuator is coupled to the tool head and operatively coupled to the die assembly to actuate the die assembly during the crimping operation. A lighting assembly is removably coupled to the frame proximate to the crimping zone that illuminates the crimping zone.

In a further embodiment, a crimping tool head is provided including a frame having first and second jaws being movable relative to one another. First and second crimping dies are coupled to the first and second crimping jaws, respectively. The first and second crimping dies define a crimping zone therebetween and are configured to crimp a terminal to a wire in the crimping zone during a crimping operation. A lighting assembly is coupled to the frame proximate to the crimping zone. The lighting assembly illuminates the crimping zone.

### BRIEF DESCRIPTION OF THE DRAWINGS

FIG. 1 is a front view of a crimping tool including a lighting assembly formed in accordance with an exemplary embodiment.

FIG. 2 is a cross-sectional view of the lighting assembly shown in FIG. 1.

FIG. 3 is a bottom view of the lighting assembly shown in FIG. 1.

FIG. 4 is a front view of the crimping tool utilizing the lighting assembly in an alternative position.

FIG. 5 is a front view of an alternative crimping tool including an alternative lighting assembly.

FIG. 6 is a front view of an alternative crimping tool including an alternative lighting assembly.

FIGS. 7 and 8 are front views of an alternative crimping tool including an alternative lighting assembly.

FIG. 9 is a side view of an alternative crimping tool including an alternative lighting assembly.

### DETAILED DESCRIPTION OF THE INVENTION

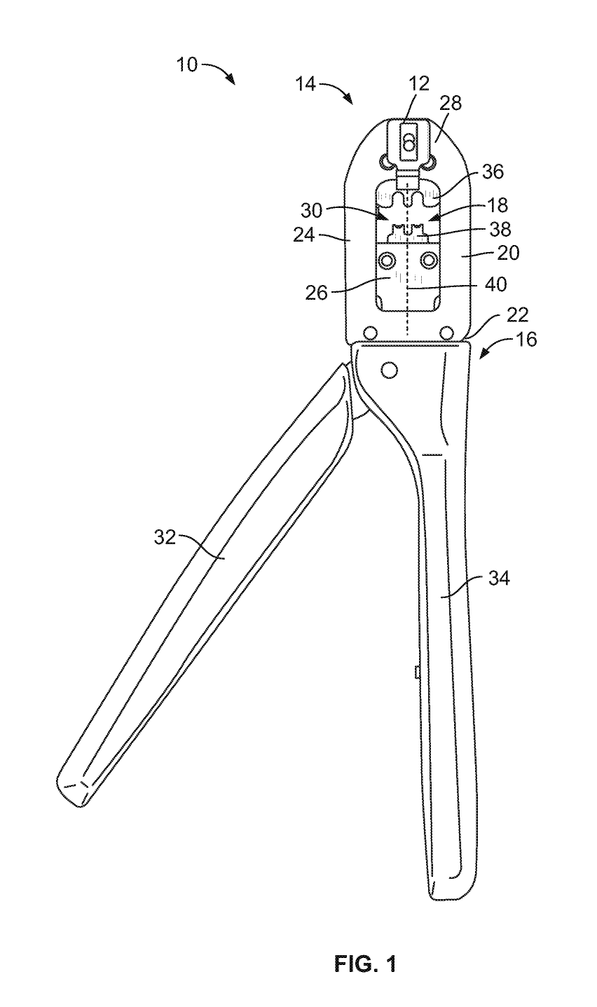

FIG. 1 is a front view of a crimping tool 10 including a lighting assembly 12 formed in accordance with an exemplary embodiment. The crimping tool 10 includes a tool head 14 and an actuator 16, with the tool head 14 being mounted to the actuator 16. The lighting assembly 12 is coupled to the tool head 14 and provides illumination focused on a crimping zone 18 of the tool head 14. The lighting assembly 12 closely positions the lighting at the crimping zone 18. In the illustrated embodiment, the actuator 16 is represented by a handle and may be referred to hereinafter as handle 16. In alternative embodiments, the actuator 16 may be another type of actuator, such as a hydraulic actuator, a pneumatic actuator, and the like. In an exemplary embodiment, the crimping tool 10 is a hand-held tool configured to be held by one or two hands of the operator.

The tool head 14 includes a frame 20 having a mounting end 22 mounted to the actuator 16. The frame 20 includes a first jaw 24 and a second jaw 26. The first and second jaws 24, 26 are movable with respect to one another as the actuator 16 is actuated. In the illustrated embodiment, the first jaw 24 constitutes a fixed jaw and the second jaw 26 constitutes a movable jaw. The first jaw 24 includes a jaw arm 28 generally opposite the second jaw 26. During operation, the second jaw 26 is moved relatively closer to the jaw arm 28 of the first jaw 24 to close an opening 30 defined therebetween. The opening 30 defines the crimping zone 18 of the tool 10. The opening 30 may be effectively closed during actuation of the actuator 16. In an alternative embodiment, both jaws 24, 26 may be movable and move toward one another as the actuator 16 is actuated.

In the illustrated embodiment, the frame 20 is a closed frame, where the frame 20 entirely surrounds the opening 30. The second jaw 26 is movable within the opening 30 to close the crimping zone 18. In an alternative embodiment, the frame 20 may be an open frame with one side being open to the opening 30. For example, the frame 20 may be C-shaped. The second jaw 26 may be moved in a linear manner, or alternatively, may be rotated closed. In another alternative embodiment, the frame 20 may be a latching type of frame having a latching arm that is rotated between an open position and a closed position, thus forming a hybrid between an open frame and a closed frame. The latching frame is closed during the crimping operation, but may be opened after the crimping operation, such as to remove the crimped terminal and wire from the crimping zone 18.

In an exemplary embodiment, the actuator 16 includes a lever 32 and an arm 34, with the second jaw 26 being connected to the lever 32. The first jaw 24 may be coupled to, or integrally formed with, the arm 34. The arm 34 of the actuator 16 is stationary relative to the tool head 14, while the lever 32 is movable relative to the tool head 14 along an arcuate path. In addition or alternative to the lever 32, the arm 34 is optionally movable relative to the tool head 14. The lever 32 may be squeezed or pressed toward the arm 34 during actuation to perform the crimping operation. As the lever 32 is closed, the second jaw 26 is moved relatively closer to the first jaw 24. In operation of the crimping tool 10, one or more workpieces, such as a terminal and a wire (not shown), are positioned in the crimping zone 18 between the first and second jaws 24 and 26. The lever 32 and the arm 34 are squeezed together, for example using one or both hands of a user. The closing action of the lever 32 and the arm 34 is transferred to relative motion of the second jaw 26 to close the second jaw 26 toward the jaw arm 28.

Both the first and second jaws 24, 26 include crimping dies 36, 38 coupled thereto. The crimping dies 36, 38 crimp the terminal to the wire when the first and/or second jaws 24, 26 are closed. The crimping dies 36, 38 may be coupled to, or integrally formed into, the pressing ends of the first and second jaws 24, 26, respectively. For example, the crimping dies 36, 38 have a complementary size and/or shape relative to the workpiece before crimping and/or relative to a predetermined crimped size and/or shape of the workpiece. In an alternative embodiment, the pressing ends of the first and second jaws 24, 26, respectively, define the crimping dies 36, 38 and directly engage the workpiece during crimping of the workpiece.

In an exemplary embodiment, the crimping tool 10 is what is commonly referred to as a “straight action” crimping tool. Specifically, the relative movement between the first and second jaws 24, 26 is linear, or straight, along a crimp axis 40. Alternatively, the crimping tool 10 is what is commonly referred to as a “scissor-action” tool, wherein the relative movement between the opposing first and second jaws 24, 26 is curved along a curved axis.

In the illustrated embodiment, the lighting assembly 12 is coupled to the tool head 14. Optionally, the lighting assembly 12 may be removably coupled to the tool head 14, such as to the frame 20. As such, the lighting assembly 12 may be removed, repositioned, adjusted and the like. The lighting assembly 12 may also be removed and placed on another crimping tool 10 that is of the same type or of a different type than the crimping tool 10 illustrated in FIG. 1. For example, the lighting assembly 12 may be mounted to a flat surface of the frame 20, and may be mounted to any flat surface of the crimping tool 10 or another crimping tool. The lighting assembly 12 may be capable of being attached and removed many times throughout the life of the lighting assembly 12. In the illustrated embodiment, the lighting assembly 12 is mounted to the jaw arm 28 of the first jaw 24. Alternatively, the lighting assembly 12 may be mounted to the second jaw 26. The lighting assembly 12 may be coupled to the tool head 14 by a tool-less operation. In other alternative embodiments, the lighting assembly 12 may be coupled to another part of the crimping tool 10, such as a locator (not shown) used with the crimping tool 10, the crimping dies 36, 38, the actuator 14, or any other appropriate part of the crimping tool 10 that would allow the lighting assembly 12 to illuminate the crimping zone 18.

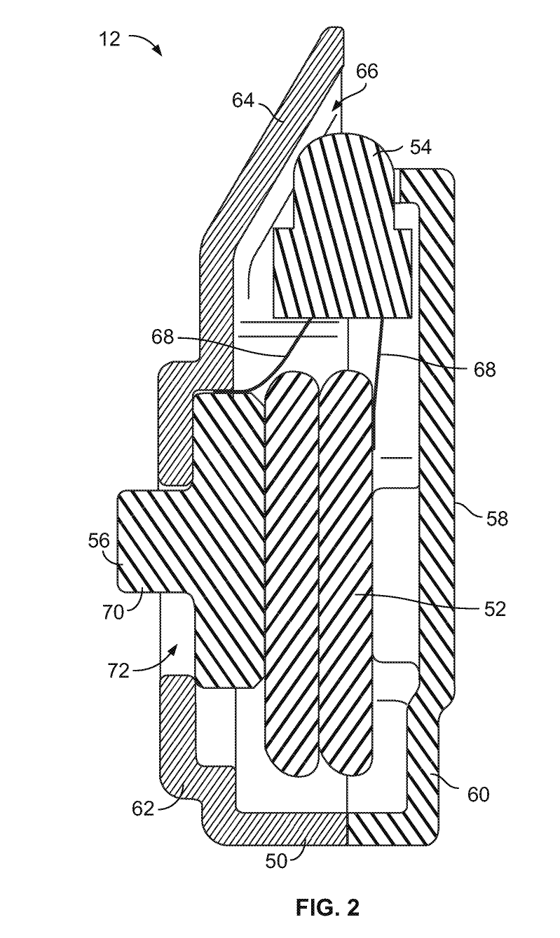

FIG. 2 is a cross-sectional view of the lighting assembly 12. The lighting assembly 12 includes a housing 50 holding a power source 52, a light source 54 and a switch 56. The housing 50 includes a mounting end 58 configured to be mounted to the tool head 14 (shown in FIG. 1). Optionally, the housing 50 may be a two piece housing with a base 60 and a cover 62. The power source 52, light source 54 and switch 56 may be assembled within the base 60 and then covered by the cover 62. The housing 50 includes shroud 64 proximate to the light source 54. Optionally, the shroud 64 extends beyond an end of the base 60. The light is directed from the lighting assembly 12 by the shroud 64. The shroud 64 may have an opening 66, wherein the light source 54 is exposed through the opening 66. The light emitted from the light source 54 may be focused through the opening 66. Optionally, a lens (not shown) may be provided at the opening 66 for directing the light in a particular direction and/or for focusing the light. Alternatively, the shroud 64 may be used to direct the light in a particular direction. The shroud 64 may include a reflective surface along a portion thereof for directing light toward the opening 66.

In an exemplary embodiment, the light source 54 constitutes a light emitting diode (LED), however other types of light sources may be used in alternative embodiments, such as incandescent light bulbs. The power source 52 constitutes one or more batteries. Other types of power sources may be used in alternative embodiments, including a line source from a power cord or power wire hard wired into the housing 50. The switch 56 constitutes a toggle switch that may be moved between an open state (OFF) and a closed state (ON) (shown in FIG. 2). The switch 56 completes a power circuit between the power source 52 and the light source 54. For example, the switch 56 may physically engage a lead 68 extending from the light source 54 when in the closed state. In such a state, the light source 54 is ON. In the open state, the switch 56 may be physically separate from the lead 68, thus having an open circuit. In such a state, the light source 54 is OFF. The switch 56 includes a button 70 that extends through a slot 72 in the housing 50. The button 70 is actuated by the user to move the switch between the open and closed states. The button 70 may be slid in a linear direction between the open and closed states. In an alternative embodiment, the switch 56 may be rotated between the open and closed states, such as by pressing different ends of the switch 56.

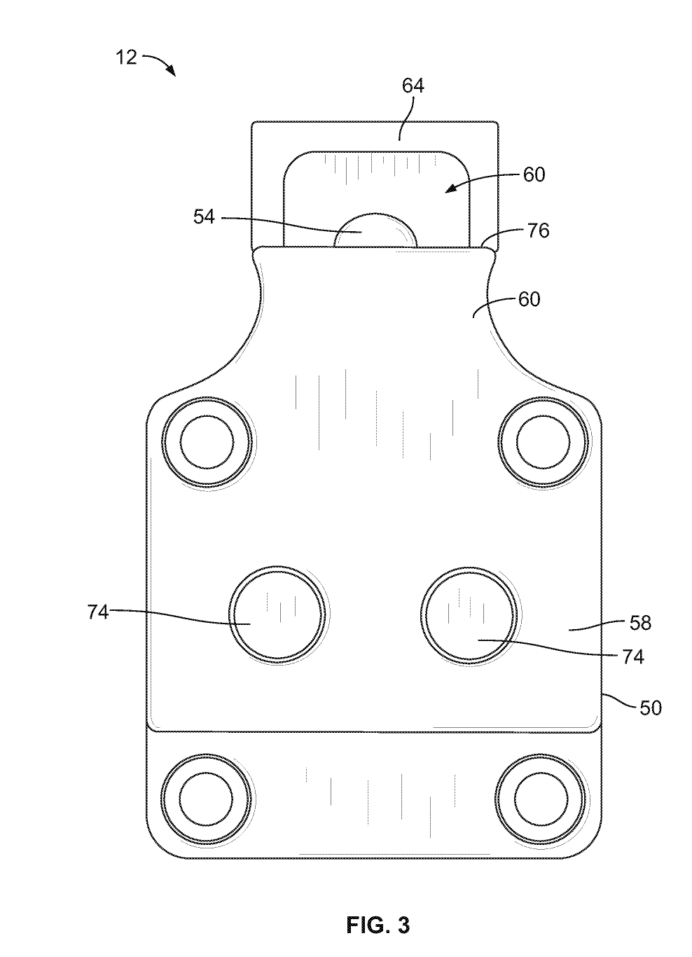

FIG. 3 is a bottom view of the lighting assembly 12 illustrating the mounting end 58 of the housing 50. The lighting assembly 12 includes fasteners 74 for securing the lighting assembly 12 to the tool head 14 (shown in FIG. 1). In the illustrated embodiment, the fasteners 74 are magnets, however other types of fasteners may be used in alternative embodiments to secure the lighting assembly 12 to the tool head 14. For example, the fasteners 74 may constitute an adhesive, a latch, a threaded fastener, solder, or another type of fastening means. Optionally, the fasteners 74 may constitute quick connect/disconnect type fasteners, such as the magnets illustrated in FIG. 3, that allow the lighting assembly 12 to be quickly and easily attached to, and removed from, the tool head 14, as opposed to a fastening means that would be a permanent connection, such as a soldered joint. The quick connect/disconnect type fasteners may allow the lighting assembly 12 to be attached and removed many times and in many different locations on the tool head 14. As such, the lighting assembly 12 can be positioned and repositioned to control the location of the lighting on the crimping zone 18 (shown in FIG. 1). Such ease of positioning allows the operator to achieve the desired lighting in a reliable manner.

The shroud 64 is shown extending beyond an edge 76 of the base 60. The opening 66 is open from below the shroud 64 to expose a portion of the light source 54. The light emitted from the light source 54 may be directed downward through the opening 66 and/or forward from the edge 76. In an alternative embodiment, the base 60 may include an opening therethrough aligned with the light source 54, wherein light is emitted through the opening in the base 60.

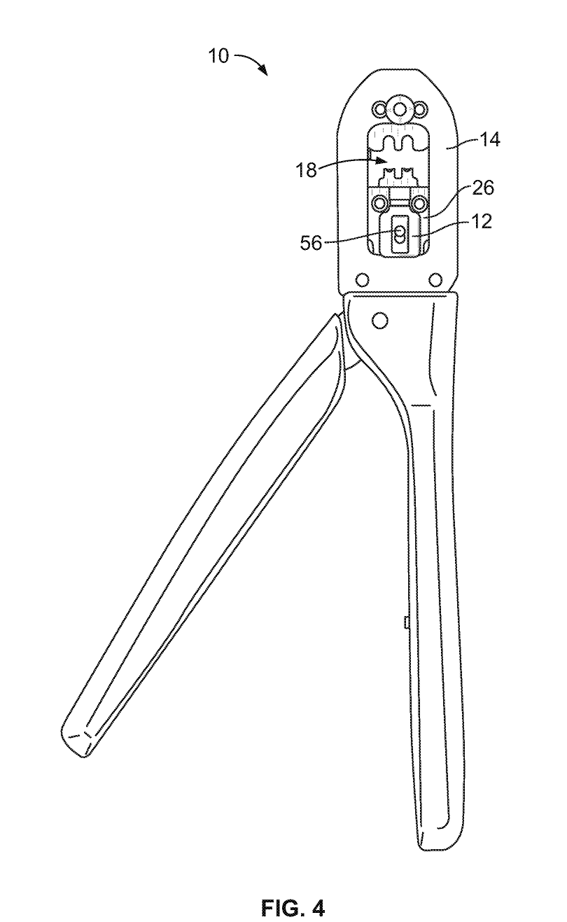

FIG. 4 is a front view of the crimping tool 10 utilizing the lighting assembly 12 in an alternative position. In the illustrated embodiment, the lighting assembly 12 is mounted to the second jaw 26 of the tool head 14. The second jaw 26 is manufactured from a material that may be ferromagnetic such that the magnetic fasteners 74 (shown in FIG. 3) secure the lighting assembly 12 to the second jaw 26. Other, non-magnetic, types of fasteners may be used in alternative embodiments to secure the lighting assembly 12 to the second jaw 26, and the second jaw 26 may be manufactured from other, non-ferromagnetic materials in such embodiments.

The lighting assembly 12 is mounted to the second jaw 26 such that the light source 54 (shown in FIG. 3) is positioned proximate to the crimping zone 18. As such, the light may be directed directly into the crimping zone 18 without other parts of the tool head 14 blocking the light path. Having the lighting assembly 12 proximate to the crimping zone 18 makes it easy and convenient for the operator to turn the lighting assembly on and off, as the switch 56 is located in the vicinity of the crimping zone 18, where the operator is already working with the workpieces.

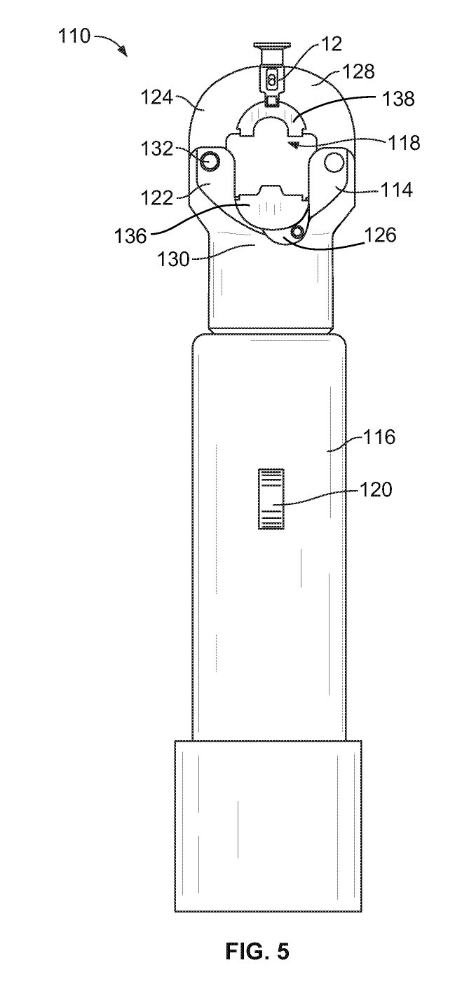

FIG. 5 is a front view of an alternative crimping tool 110 including the lighting assembly 12 coupled thereto. The crimping tool 110 includes a tool head 114 and an actuator 116 mounted to the tool head 114. The lighting assembly 12 is coupled to the tool head 114 and provides illumination focused on a crimping zone 118 of the tool head 114. The lighting assembly 12 closely positions the lighting at the crimping zone 118. In the illustrated embodiment, the actuator 116 is represented by a battery powered hydraulic actuator. The crimping tool 110 is handheld. The hydraulic actuator 116 is activated by a switch 120.

The tool head 114 includes a frame 122 having a first jaw 124 and a second jaw 126. The first jaw 124 includes an upper jaw arm 128 and a lower jaw arm 130 coupled together by pins 132. The second jaw 126 is movable with respect to the first jaw 124 when the actuator 116 is activated. Crimping dies 136, 138 may be coupled to the first and second jaws 124, 126. For example, the crimping dies may be similar to the crimping dies 36, 38 (shown in FIG. 1). In the illustrated embodiment, the lighting assembly 12 is mounted to the upper jaw arm 128, however alternative placements are possible in alternative embodiments, such as on the lower jaw arm 130 or on the second jaw 126. The lighting assembly 12 is positioned proximate to the crimping zone 118 to illuminate the crimping zone 118.

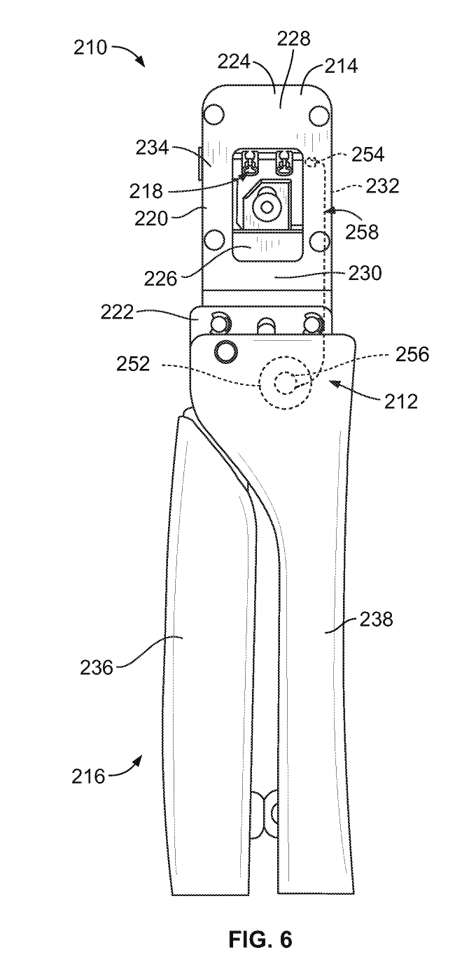

FIG. 6 is a front view of an alternative crimping tool 210 including an alternative lighting assembly 212. The crimping tool 210 is similar to the crimping tool 10 (shown in FIG. 1) in some respects, however the crimping tool 210 includes different features directed at the lighting assembly 212.

The crimping tool 210 includes a tool head 214 and an actuator 216, with the tool head 214 being mounted to the actuator 216. The lighting assembly 212 is coupled to both the tool head 214 and the actuator 216. The lighting assembly 212 provides illumination focused on a crimping zone 218 of the tool head 214. The lighting assembly 212 closely positions the lighting at the crimping zone 218.

The tool head 214 includes a frame 220 having a mounting end 222 mounted to the actuator 216. The frame 220 includes a first jaw 224 and a second jaw 226. The first and second jaws 224, 226 are movable with respect to one another as the actuator 216 is actuated. In the illustrated embodiment, the first jaw 224 constitutes a fixed jaw and the second jaw 226 constitutes a movable jaw. The first jaw 224 includes an upper jaw arm 228 generally opposite the second jaw 226. The first jaw 224 also includes a lower jaw arm 230 opposite the upper jaw arm 228 and side jaw arms 232, 234 extending between the upper and lower jaw arms 228, 230. During operation, the second jaw 226 is moved generally parallel to the side jaw arms 232, 234 relatively closer to the upper jaw arm 228. As the second jaw 226 is moved along a crimp stroke, the second jaw 226 closes the crimping zone 218. In an alternative embodiment, both jaws 224, 226 may be movable and move toward one another as the actuator 216 is actuated.

In an exemplary embodiment, the actuator 216 includes a lever 236 and an arm 238, with the second jaw 226 being connected to the lever 236. The actuator 216 functions similarly to the actuator 16 (shown in FIG. 1).

The lighting assembly 212 includes a power source 252, a light source 254 and a switch 256. The light source 254 constitutes a light emitting diode (LED), however other types of light sources may be used in alternative embodiments, such as incandescent light bulbs. The light source 254 is coupled to the tool head 214. The light source 254 is coupled to the first jaw 226 proximate to the crimping zone 218. Optionally, the light source 254 may be embedded within the first jaw 226, such as in the side jaw arm 232. For example, the first jaw 224 may include multiple plates coupled together, with the plates spaced apart from one another by spacers (not shown). The light source 254 may be received within the space between the plates.

The power source 252 constitutes one or more batteries. Other types of power sources may be used in alternative embodiments, including a line source from a power cord or power wire hard wired into the crimping tool 210. In the illustrated embodiment, the power source 252 is coupled to the arm 238. The power source 252 may be embedded within the arm 238. The power source 252 is connected to the light source 254 by a wire 258 routed through the arm 238 and a portion of the tool head 214.

The switch 256 constitutes a push button switch. In the illustrated embodiment, the switch 256 is coupled to the arm 238. The switch 256 may be embedded within the arm 238. The switch 256 is turned on by pressing the switch 256. Optionally, the switch 256 may remain in the ON state or the OFF state until the switch 256 is pressed inward again. Alternatively, the switch 256 may only be in the ON state when the operator physically holds the switch 256 inward. When the operator lets go of the switch 256, the switch 256 may then automatically return to the OFF state. The switch 256 may be activated through a handle grip or other item covering the switch 256. Other types of switches are possible in alternative embodiments.

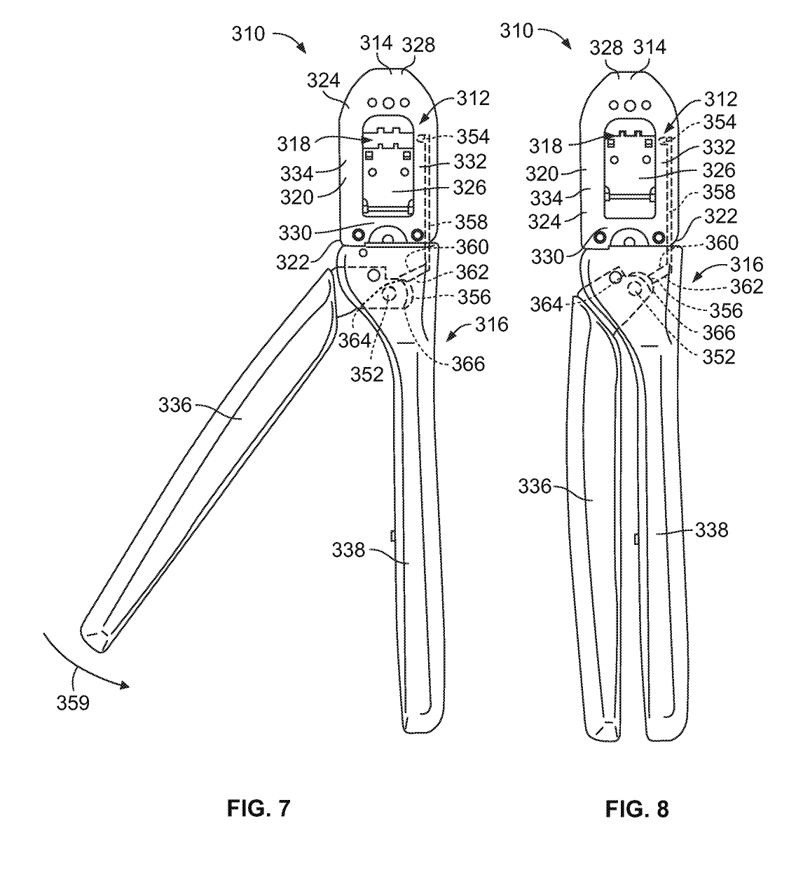

FIGS. 7 and 8 are side views of an alternative crimping tool 310 including an alternative lighting assembly 312 in an open and closed state, respectively. The crimping tool 310 is similar to the crimping tool 210 (shown in FIG. 6) in some respects, however the crimping tool 310 includes different features directed at the lighting assembly 312.

The crimping tool 310 includes a tool head 314 and an actuator 316. The lighting assembly 312 is coupled to both the tool head 314 and the actuator 316. The lighting assembly 312 provides illumination focused on a crimping zone 318 of the tool head 314. The lighting assembly 312 closely positions the lighting at the crimping zone 318.

The tool head 314 includes a frame 320 having a mounting end 322 mounted to the actuator 316. The frame 320 includes a first jaw 324 and a second jaw 326. The first and second jaws 324, 326 are movable with respect to one another as the actuator 316 is actuated. In the illustrated embodiment, the first jaw 324 constitutes a fixed jaw and the second jaw 326 constitutes a movable jaw. The first jaw 324 includes an upper jaw arm 328 generally opposite the second jaw 326. The first jaw 324 also includes a lower jaw arm 330 opposite the upper jaw arm 328 and side jaw arms 332, 334 extending between the upper and lower jaw arms 328, 330. During operation, the second jaw 326 is moved generally parallel to the side jaw arms 332, 334 relatively closer to the upper jaw arm 328. As the second jaw 326 is moved along a crimp stroke, the second jaw 326 closes the crimping zone 318. In an alternative embodiment, both the first and second jaws 324, 326 may be movable and move toward one another as the actuator 316 is actuated.

In an exemplary embodiment, the actuator 316 includes a lever 336 and an arm 338, with the second jaw 326 being connected to the lever 336. The actuator 316 functions similarly to the actuator 216 (shown in FIG. 6).

The lighting assembly 312 includes a power source 352, a light source 354 and a switch 356. The light source 354 constitutes a light emitting diode (LED), however other types of light sources may be used in alternative embodiments, such as incandescent light bulbs. The light source 354 is coupled to the tool head 314. The light source 354 is coupled to the first jaw 324 proximate to the crimping zone 318. Optionally, the light source 354 may be embedded within the first jaw 324, such as in the side jaw arm 332.

The power source 352 constitutes one or more batteries. Other types of power sources may be used in alternative embodiments, including a line source from a power cord or power wire hard wired into the crimping tool 310. In the illustrated embodiment, the power source 352 is coupled to the lever 336. The power source 352 may be embedded within the lever 336. The power source 352 is connected to the light source 354 by a wire 358 routed through the arm 338 and a portion of the tool head 314.

The switch 356 forms a portion of the lever 336. In the illustrated embodiment, the switch 356 is provided at an end of the lever 336. When the lever 336 is completely open, the switch 356 is in an OFF state. The switch 356 is activated by squeezing the lever 336 in a closing direction 359. As the lever 336 begins to close, the switch 356 engages both leads 360, 362 of the wire 358, thereby completing or closing the circuit. Optionally, the switch 356 may be closed by only partial movement of the lever 336 in the closed direction 359. For example, closing of the lever 336 approximately 10% of the entire closing stroke. The lever 336 may be closed more or less than 10% of the closing stroke in alternative embodiments to close the switch 356. Further closing of the lever 336 maintains the switch 356 in a closed position. For example, the switch 356 may be a metal contact extending between a first end 364 and a second end 366. Once the first end 364 engages the lead 360, the switch is closed. As portions of the contact between the first and second ends 364, 366 are in engagement with both leads 360, 362, the switch 356 remains closed. Closing the switch 356 electrically connects the power source 352 with the light source 354 and thus turns the light source 354 on.

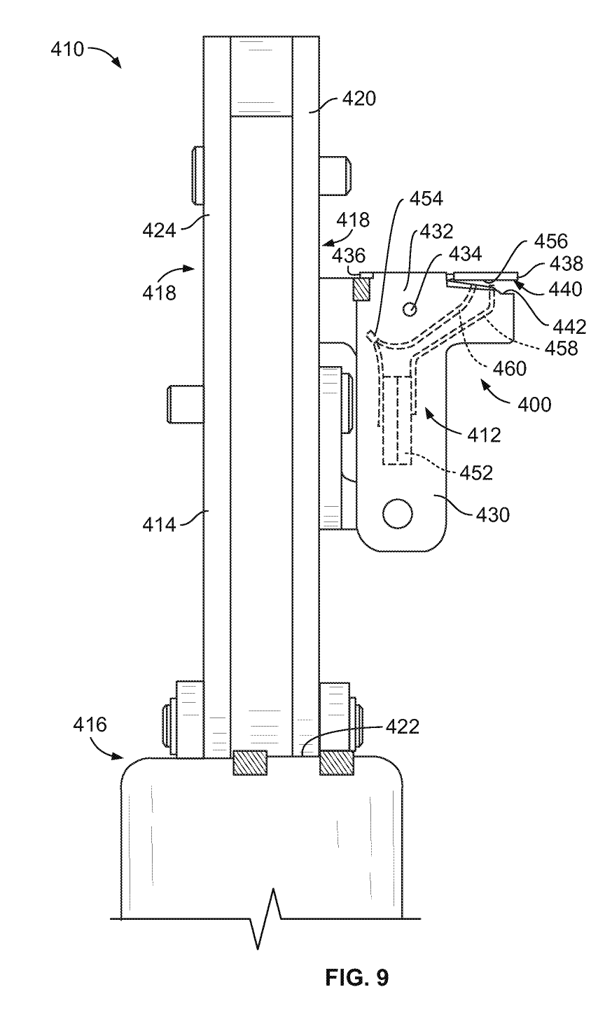

FIG. 9 is a side view of an alternative crimping tool 410 having an alternative lighting assembly 412. The crimping tool 410 may be similar to the crimping tool 10, however the crimping tool 410 includes a locator 400 with the lighting assembly 412 coupled to the locator 400.

The crimping tool 410 includes a tool head 414 and an actuator 416 (only an upper portion of the actuator 416 is illustrated in FIG. 9). The locator 400 is coupled to the tool head 414 proximate to a crimping zone 418. A portion of the locator 400 may extend into and/or define part of the crimping zone 418. The locator 400 is configured to locate the workpieces within the crimping zone 418. For example, the locator 400 may locate a terminal and/or a wire within the crimping zone 418. The lighting assembly 412 is coupled to the locator 400 and provides illumination focused on the locator 400 and/or the crimping zone 418 of the tool head 414. The lighting assembly 412 closely positions the lighting at the crimping zone 418 and locator 400.

The tool head 414 includes a frame 420 having a mounting end 422 mounted to the actuator 416. The frame 420 includes a first jaw 424 and a second jaw (not shown).

The locator 400 includes a locator body 430 coupled to the frame 420. The locator 400 also includes a terminal holder 432 coupled to the locator body 430. In the illustrated embodiment, the terminal holder 432 is pivotably coupled to the locator body 430 at a pivot point 434. A front end 436 of the terminal holder 432 normally rests on the locator body 430. In operation, a rear end 438 of the terminal holder 432 is pressed downward toward the terminal holder 432 to raise the front end 436 away from the locator body 430 to create a space that receives the terminal. When a terminal is loaded between the terminal holder 432 and the locator body 430, the terminal is held in place by the terminal holder 432. A space 440 is provided between the rear end 438 and a top surface 442 of the locator body 430 to allow for the pivoting of the terminal holder 432. Optionally, a spring may be provided between the rear end 438 and the locator body 430 that generally forces the terminal holder 432 to the normal position (shown in FIG. 9). As such, the front end 436 is clamped downward onto any terminal positioned between the front end 436 and the top surface 442 of the locator body 430.

The lighting assembly 412 includes a power source 452, a light source 454 and a switch 456. The light source 454 constitutes a light emitting diode (LED), however other types of light sources may be used in alternative embodiments, such as incandescent light bulbs. The light source 454 is coupled to the locator 400. In an exemplary embodiment, the light source 454 is embedded within the locator body 430, which is manufactured from a transparent, semi-transparent, translucent or semi-translucent material to allow the light to emit from the locator body 430. In an alternative embodiment, the locator body 430 includes an opening therethrough that allows the light to be emitted from the locator body 430. In another alternative embodiment, the light source 454 is provided on an exterior surface of the locator body 430. The light from the light source 454 is emitted toward the crimping zone 418 and/or the loading area for the terminal with respect to the terminal holder 432.

The power source 452 constitutes one or more batteries. Other types of power sources may be used in alternative embodiments, including a line source from a power cord or power wire hard wired into the crimping tool 410. In the illustrated embodiment, the power source 452 is embedded within the locator 430. The power source 452 may be coupled to the locator by other means, and may be coupled external of the locator body 430. Optionally, the power source 452 may be remote from the locator 400, but may be electrically connected to the light source 454 by a wire.

The switch 456 is coupled to the locator 400. In the illustrated embodiment, the terminal holder 432 is metallic and constitutes the switch 456, wherein leads 458, 460 are provided on the top surface 442 of the locator body 430 generally aligned with the rear end 438 of the terminal holder 432. Alternatively, a metal plate, which defines the electrical portion of the switch 456, may be coupled to the terminal holder 432, which defines the mechanical portion of the switch, to engage the leads 458, 460 rather than the terminal holder 432 itself defining the both the mechanical and electrical portions of the switch 456. The leads 458, 460 connect the power source 452 with the light source 454. As the rear end 438 is pushed downward and engages the top surface 442, and thus the leads 458, 460, the power circuit is closed. The power circuit remains closed as long as the terminal holder 432 is in use, being pressed by the operator and/or holding the terminal. Once the terminal is removed from the crimping zone 418, the terminal holder 432 is released and the power circuit is opened, thus shutting off power to the light source 454.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A crimping tool for crimping a terminal to a wire, the crimping tool comprising:
a tool head having a die assembly defining a crimping zone, the die assembly being configured to crimp the terminal to the wire in the crimping zone during a crimping operation;
an actuator coupled to the tool head, the actuator operatively coupled to the die assembly to actuate the die assembly during the crimping operation; and
a lighting assembly coupled to the tool head, the lighting assembly illuminating the crimping zone.

2. The crimping tool of claim 1, wherein the lighting assembly is removably coupled to the tool head.

3. The crimping tool of claim 1, wherein the lighting assembly includes a housing having a mounting end, the mounting end being coupled to the tool head by a fastener, the fastener being removably coupled to the tool head.

4. The crimping tool of claim 1, wherein the lighting assembly includes a housing having a mounting end, the mounting end being coupled to the tool head by a magnetic fastener, the magnetic fastener being removably coupled to the tool head.

5. The crimping tool of claim 1, wherein the lighting assembly includes a housing having a mounting end, the mounting end being coupled to the tool head by a quick connect/disconnect fastener, the quick connect/disconnect fastener allowing the lighting assembly to be attached to and removed from the tool head multiple times.

6. The crimping tool of claim 1, wherein the tool head further comprises a locator configured to locate the terminal with respect to the crimping zone, the lighting assembly being coupled to the locator.

7. The crimping tool of claim 1, wherein the tool head further comprises a locator configured to locate the terminal with respect to the crimping zone, the lighting assembly being embedded within the locator.

8. The crimping tool of claim 1, wherein the tool head further comprises a locator configured to locate the terminal with respect to the crimping zone, the lighting assembly illuminating the locator from within a body of the locator.

9. The crimping tool of claim 1, wherein the tool head further comprises a locator having a terminal holder configured to hold the terminal in the crimping zone, the lighting assembly being coupled to the locator and including a power source and a light source powered by the power source, the terminal holder defining a switch operatively coupled to the power source to operate the light source.

10. The crimping tool of claim 1, wherein the lighting assembly includes a power source, a light source powered by the power source, and a switch operatively coupled to the light source, the lighting assembly further including a housing receiving the power source, the light source and the switch, the housing being mounted to the tool head.

11. The crimping tool of claim 1, wherein the lighting assembly includes a power source, a light source powered by the power source, and a switch operatively coupled to the light source, the light source being coupled to the tool head, at least one of the power source or the switch being remote from the tool head.

12. The crimping tool of claim 1, wherein the lighting assembly includes a power source, a light source powered by the power source, and a switch operatively coupled to the light source, the light source being coupled to the tool head, the power source and the switch being coupled to the actuator, the light source being electrically connected to the power source by a wire routed through the tool head.

13. The crimping tool of claim 1, wherein the lighting assembly is configured to be coupled to the tool head by a tool-less operation.

14. A crimping tool for crimping a terminal to a wire, the crimping tool comprising:
a tool head having a frame and a die assembly coupled to the frame, the die assembly defining a crimping zone, the die assembly being configured to crimp the terminal to the wire in the crimping zone during a crimping operation;
an actuator coupled to the tool head, the actuator operatively coupled to the die assembly to actuate the die assembly during the crimping operation; and
a lighting assembly removably coupled to the frame proximate to the crimping zone, the lighting assembly illuminating the crimping zone.

15. The crimping tool of claim 14, wherein the lighting assembly includes a housing having a mounting end, the mounting end being coupled to the tool head by a fastener, the fastener being removably coupled to the tool head.

16. The crimping tool of claim 14, wherein the lighting assembly includes a power source, a light source powered by the power source, and a switch operatively coupled to the light source, the lighting assembly further including a housing receiving the power source, the light source and the switch, the housing being mounted to the tool head.

17. The crimping tool of claim 14, wherein the frame includes first and second jaws being movable relative to one another; and wherein the die assembly includes first and second crimping dies coupled to the first and second crimping jaws, respectively, the first and second crimping dies defining the crimping zone therebetween.

18. The crimping tool of claim 14, wherein the tool head further comprises a locator configured to locate the terminal with respect to the crimping zone, the lighting assembly being coupled to the locator.

19. A crimping tool head comprising:
a frame having first and second jaws, the first and second jaws being movable relative to one another;
first and second crimping dies coupled to the first and second crimping jaws, respectively, the first and second crimping dies defining a crimping zone therebetween, the first and second crimping dies being configured to crimp a terminal to a wire in the crimping zone during a crimping operation; and
a lighting assembly coupled to the frame proximate to the crimping zone, the lighting assembly illuminating the crimping zone.

20. The crimping tool head of claim 19, wherein the lighting assembly includes a housing having a mounting end, the mounting end being coupled to the tool head by a fastener, the fastener being removably coupled to the tool head.
